(19) United States
(12) Patent Application Publication
(10) Pub. No.: US 2017/0055542 A1
(43) Pub. Date: Mar. 2, 2017

(54) Methods And Systems For Modifying Coffee Beans

(71) Applicant: Lunatech, LLC, Studio City, CA (US)

(72) Inventor: John Cameron, Studio City, CA (US)

(21) Appl. No.: 15/252,842

(22) Filed: Aug. 31, 2016

Related U.S. Application Data
(60) Provisional application No. 62/212,470, filed on Aug. 31, 2015.

(51) Int. Cl. A23F 5/36; A23L 33/10; A23P 10/28; A47J 42/00

(52) U.S. Cl. CPC A23F 5/36; A47J 42/00; A23L 33/10; A23P 10/28; A23V 2002/00

(57) ABSTRACT

Provided are methods and systems for creating simulated coffee beans by using processed natural coffee beans with additional ingredients and then reforming the combination of ingredients via a manufacturing process into coffee bean appearance forms. In an aspect, an example method can comprise receiving a plurality of coffee beans, grinding the plurality of coffee beans into coffee grounds, forming a mixture by adding at least one additive to the coffee grounds, and forming the mixture into a plurality of bean-shaped objects.

### CROSS REFERENCE TO RELATED PATENT APPLICATION

This application claims priority to U.S. Provisional Application No. 62/212,470 filed Aug. 31, 2015, here incorporated by reference in its entirety.

### BACKGROUND

Consumers enjoy the many nuanced flavors and textures available for specialty food products, such as coffee. As technology improves, consumers are looking for new ways to consume and customize food products. Currently, users are unable to participate in the customization of coffee beans before packaging by the manufacturer. Thus, there is need for methods and systems that allow greater customization of coffee.

### SUMMARY

It is to be understood that both the following general description and the following detailed description are exemplary and explanatory only and are not restrictive, as claimed. Provided are methods and systems for creating simulated coffee beans by using processed natural coffee beans with additional ingredients and then reforming the combination of ingredients via a manufacturing process into coffee bean appearance forms.

In an aspect, an example method can comprise receiving a plurality of coffee beans, grinding the plurality of coffee beans into coffee grounds, forming a mixture by adding at least one additive to the coffee grounds, and forming the mixture into a plurality of bean-shaped objects.

In an aspect, an example method can comprise receiving a request from a user to combine a coffee bean with an additive, grinding a coffee bean, mixing the additive with the coffee bean resulting in a mixture, forming the mixture into a bean-shaped object, and providing the bean-shaped object to the user.

In an aspect, an example system can comprise a grinder configured grinder a plurality of coffee beans into a coffee grounds, a mixer configured to mix an additive into the coffee grounds: a forming device configured to form the mixture into a plurality of bean-shaped objects, and a sealer configured to cover the plurality of bean-shaped objects with a sealing agent. The system can comprise a polisher configured to polish the plurality of bean-shaped objects covered in the sealing agent and a packager configured to package the polished plurality of bean-shaped object. The system can comprise a computing device configured to control the grinder, the mixer, the forming device, the sealer, the polisher, the packager, or a combination thereof.

In an aspect, a bean-shaped food product can comprise coffee grounds and an additive mixed with the coffee grounds, wherein the additive and the coffee grounds are formed into a bean-shaped object.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a diagram illustrating an example process for forming a modified coffee bean;

FIG. 2 is a block diagram illustrating an example system for modifying a coffee bean;

FIG. 3 is a flowchart illustrating an example process creating simulated coffee beans:

FIG. 4 is a flowchart illustrating an example method for modifying a coffee bean;

FIG. 5 is a flowchart illustrating an example method for modifying a coffee bean; and

FIG. 6 is a block diagram illustrating an example computing environment in which the present methods and systems can operate.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to the industry of the customization and reconfiguring of food and beverage products. Specifically, the methods, systems, and products disclosed utilize coffee and additives to reconfigure and replicate coffee in its original bean form. It is coffee that has been reimagined and reconfigured using technology. The “Technically Coffee” physical coffee bean end product is virtually indiscernible from an organically grown coffee bean. However, the resultant bean is a technological version of coffee, a simulated coffee bean, created for the purpose of bringing enhanced flavorings, ingredients, wellness, and health components to the coffee bean brewing experience. Each component of a Technically Coffee bean may be certified organic or there may be synthetic or non-organic elements.

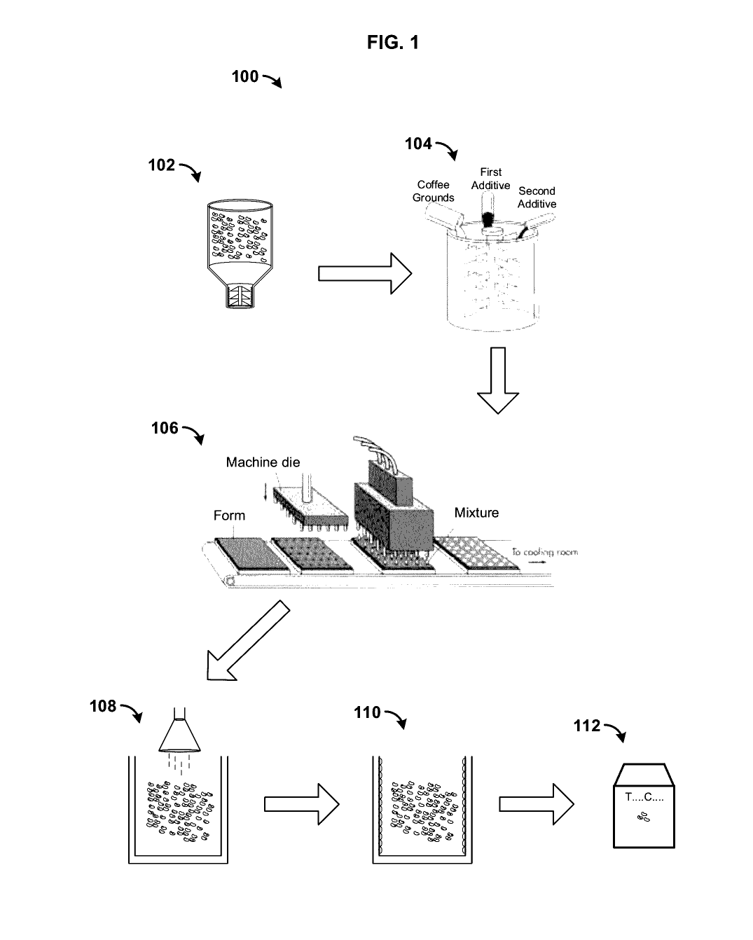

FIG. 1 is a diagram illustrating an example process 100 for forming a modified coffee bean. At step 102, the process can start by grinding coffee (e.g., regular coffee). Depending on the other ingredients involved in the process 100 the grind may be anywhere from extremely coarse to extremely powdered. Moisture (e.g., water), oil, and/or the like contents can be added to or extracted from the ground coffee. The amount of moisture can be adjusted to achieve proper binding between the ground coffee and ingredients added later on in the process (e.g., at step 104). The amount of moisture can also be adjusted to achieve a desired firmness of a finished result of the process 100 (e.g., simulated coffee bean). In an aspect, the process of adding or extracting moisture can also be done with the supplemental ingredients or in combination. In an aspect, the coffee grounds can be moistened to a level sufficient to convert the coffee grounds to a liquid form in order to fulfill the manufacturing process.

At step 104, the ground coffee can be combined with other supplemental ingredients (e.g., first additive, second additive). The supplemental ingredients can comprise flavorings including but in no way limited to sugar, smoke, cinnamon, nutmeg, bitters, a combination thereof, and/or any other flavor. The supplemental ingredients can comprise wellness elements, such as caffeine, Echinacea, vitamins, gingko biloba, kava, CBD, a combination thereof, and/or the like. The supplemental ingredients can comprise medications, such as blood pressure medication, diabetes medication, heart medication, sexual dysfunction medication, birth control medications, vitamins, and/or the like. The supplemental ingredients can comprise natural or artificial colorings to yield a desired color. The supplemental ingredients can comprise Tetrahydrocannabinol (THC), Cannabidiol (CBD), cannabinol (CBN), combinations thereof, and the like. In a further aspect, the supplemental ingredients can comprise an extract from duboisia hopwoodii. The combined ground coffee and supplemental ingredients can be combined as a mixture by grinding the coffee grounds and supplemental ingredients, blending the ground coffee grounds and supplemental ingredients, a combination thereof, and/or the like to yield a mixture. The mixture can have substantially uniform properties such as, dispersion and color.

At step 106, the mixture can be formed into a plurality of bean-shaped (e.g., or other shaped) objects by a formation device. The formation device can comprise a form presser, molding system, and/or the like. The formation device can press the combined mixture into shapes substantially like those of a coffee bean. In an aspect, the formation device can also receive the mixture in a liquid or slurry form. The formation device can provide the mixture into molds. In the case of using multiple molds, the molded pieces will be pressed together and bound in well-known food manufacturing processes of this kind. In an aspect, the bean-shaped objects can be formed by first forming the mixture into the general shape of a bean, and second have a scoring mold or die which adds a creased line to the bean (e.g., to resemble a coffee bean).

In an aspect, formation or shaping of a bean-shaped object can comprise starch casting. Dry corn starch is a fine, white powder that retains impressions or shapes well. A mogul can deposit a layer of corn starch in a plastic tray and move the tray to a machine die, which can press dent into the corn starch. Each tray may contain several hundred to thousands of these impressions or dents, each of which is the size and shape of the center of a bean-shaped object. The mogul moves the trays to a depositor or “filling station” where the mixture can be squirted into the molds. From the mogul, conveyors can move the trays to cooling rooms which temperature and humidity are controlled and where the mixture cools and sets up to form the bean-shaped object.

At step 108, optionally, the bean can be sealed with a coat of natural oil or wax to preserve the form of the beans. For example, if the bean-shaped object formed in step 106 does not have an integrity (e.g., binding strength) reaching a threshold, then step 108 can be utilized to give additional strength, integrity, and/or the like to the bean-shaped objects. In an aspect, a coating process can be utilized to impart a color element to define the desired traits of the coffee as young, dark French roast, and/or, the like.

At step 110, a buffing process can be applied to the bean-shaped objects. The bean-shaped objects can be provided to a buffer. As an example, the buffer can comprise a tube rotating with a glossing element, a tumbler buffer, and the like. The buffer can be configured to run at different intensities, such as a gentle, normal, high, and/or the like. In some scenarios, the buffer (e.g., tumbler) can comprise (e.g., or be outfitted with) softened interior walls. The interior walls can be narrowed to limit the ‘fall’ or force exerted upon the bean-shaped objects, to maintain the integrity of the bean-shaped objects.

At step 112, the bean-shaped objects can be packaged. For example, the bean-shaped objects can be bagged in the same kind of bag as typically used for selling coffee in a retail store. For example, the bean-shaped objects can be packaged in bags, tins, cartridges (e.g., for use in an automated brewing machine), and/or the like.

In an aspect, the process 100 can be implemented for mass production, or may be customized for on demand production of specific blends. For example, specific blends can be mixed using ingredients selected by customers. The customers can select from a range of available ingredients via web site, application (e.g., mobile application), communication device (e.g., telephone), and/or the like.

Once the beans are removed from the bag by the end user, the brewing process can be similar to or the same as used for ordinary coffee beans. The bean-shaped objects can be ground and then brewed (e.g., using standard coffee making grinders and brewing mechanisms). In a related embodiment, the Technically Coffee finished product can be delivered in all brewing formats as a pre-ground offering.

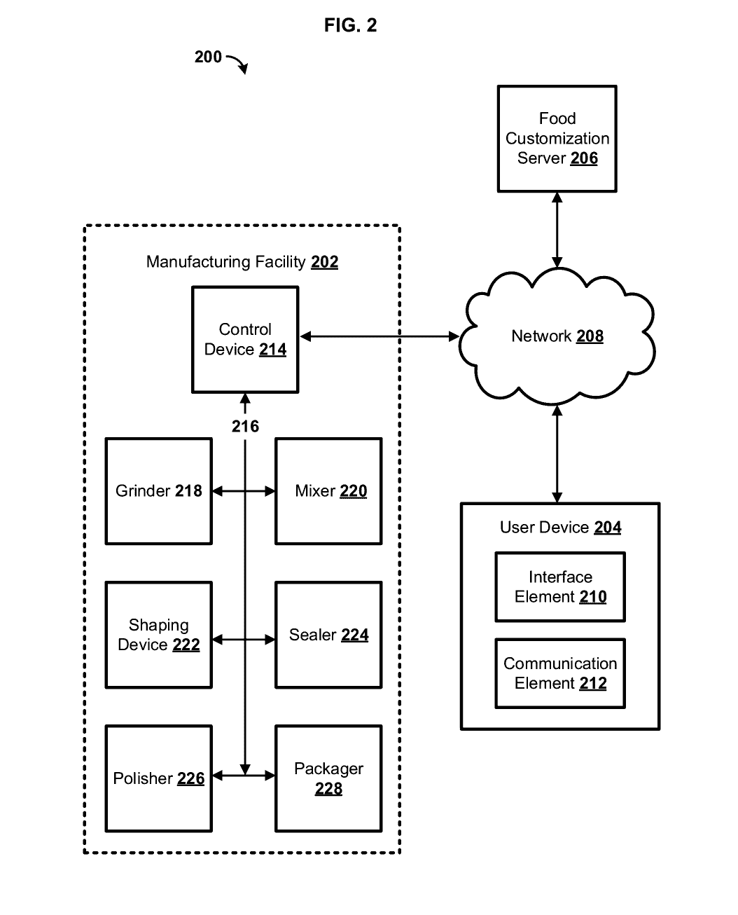

FIG. 2 is a block diagram illustrating an example system 200 for modifying a coffee bean. The system 200 can comprise a manufacturing facility 202 for modifying coffee beans, a user device 204 for ordering customized food, a food customization server 206 for processing food customization orders, a combination thereof, and/or the like.

In an aspect, the system 200 can comprise a network 208. The network 208 can comprise network adapters, switches, routers, modems, and the like connected through wireless links (e.g., radio frequency, satellite) and/or physical links (e.g., fiber optic cable, coaxial cable, Ethernet cable, or a combination thereof). The network 208 can comprise public networks, private networks, wide area networks (e.g., Internet), local area networks, and/or the like. In one aspect, the network 208 can be configured to provide communication from telephone, cellular, modem, and/or other electronic devices to and throughout the system 200. For example, the network 208 can be configured to communicatively couple one or more of a manufacturing facility 202, user device 204, food customization server 206, and/or the like.

In an aspect, the food customization server 206 can be configured to process requests for a custom food product. For example, the food customization server 206 can receive requests from uses to form a custom food product, such as a custom pellet, bean-shaped object (e.g., coffee bean-shaped object), granule, and/or the like as described herein. An example request can comprise additive information, such as the name of the additive, concentration of the additive, and/or the like. The additive can comprise vitamins, supplements, natural ingredients, medications, wellness ingredients, preservatives or any safely consumed additive consumable ingredient such as caffeine, or any combination thereof. The additive can comprise flavorings, such as sugar, smoke, cinnamon, nutmeg, bitters, a combination thereof, and/or any other flavor. The additive can comprise can comprise wellness elements, such as caffeine, Echinacea, vitamins, gingko biloba, kava, CBD, a combination thereof, and/or the like. The additive can comprise medications, such as blood pressure medication, diabetes medication, heart medication, sexual dysfunction medication, birth control medications, vitamins, and/or the like. In an aspect, the additive information can comprise a vaccine, allergy serum, and/or other medical additive. The additive can comprise natural or artificial colorings to yield a desired color. The additive can comprise Tetrahydrocannabinol (THC), Cannabidiol (CBD), cannabinol (CBN), combinations thereof, and the like. In a further aspect, the additive can comprise an extract from duboisia hopwoodii. For example, the custom food product can be provided to the user instead of a vaccine shot, allergy shot, and/or the like.

The request can specify properties of the custom food product, such as hardness, color, shape, form, and, or the like. The food customization server 206 can identify additional additives based on the specified properties, such as binding agents, coloring agents and/or the like. For example, the identified additive can comprise a liquid, such as water, oil, and/or the like. The identified additive can comprise a binding agent configured to bind the coffee grounds together and/or bind the coffee grounds to other additives. In another aspect, the user can specify the identified additive.

In an aspect, the food customization server 206 can be configured to retrieve information based on the user request. For example, the food customization server 206 can be configured to retrieve medical information, such as medical records, prescription details, and/or the like associated with the user requesting the custom food. The food customization server 206 can determine a concentration for the additive based on the retrieved medical information. For example, the concentration can be such that a serving (e.g., an amount needed to brew a cup using the customized food) of the customized food provides a dosage of the additive specified in the medical information.

In an aspect, the system 200 can comprise a user device 204. The user device 204 can be configured to provide services, information, applications, and/or the like to one or more users. For example, the user device 204 can comprise a computer, a smart device (e.g., smart phone, smart watch, smart glasses, smart apparel, smart accessory), a laptop, a tablet, a set top box, a display device (e.g., television, monitor), digital streaming device, proxy, gateway, transportation device (e.g., on board computer, navigation system, vehicle media center), sensor node, and/or the like.

In one aspect, the user device 204 can comprise an interface element 210 configured to provide an interface to a user to interact with the user device 204 and/or remote devices, such as the food customization server 206. The interface element 210 can be any interface for presenting and/or receiving information to/from the user, such as user feedback. An example interface can comprise a content viewer, such as a web browser (e.g., Internet Explorer®, Mozilla Firefox®, Google Chrome*, Safari*, or the like), media player, application (e.g., web application, mobile application, media device application), and/or the like. Other software, hardware, and/or interfaces can be used to provide communication between the user and one or more of the manufacturing facility 202 and the food customization server 206.

In an aspect, the interface can be configured to allow a user to provide requests to a food customization server 206. For example, a request can comprise a request to mix an additive to a coffee bean or blend of coffee beans. The request can comprise additive information as described herein. For example, that additive information can comprise a name, concentration of the additive, and/or the like. The request can comprise result information, such as a resulting shape, form, color, hardness, and/or the like of the resulting mixture of the additive with the coffee beans.

In an aspect, the user device 204 can comprise a communication element 212. As an example, the communication element 212 can request or query various files from a local source and/or a remote source. As a further example, the communication element 212 can transmit and/or receive data to a local or remote device such as the food customization server 206. The communication element 212 can comprise hardware and/or software to facilitate communication. For example, the communication element 212 can comprise one or more of a modem, transceiver (e.g., wireless transceiver)), digital-to-analog converter, analog-to-digital converter, encoder, decoder, modulator, demodulator, tuner, and/or the like. In one aspect, the communication element 212 can be configured to allow one or more remote devices (e.g., in a local or remote portion of the network 208) to control operation of the user device 204.

In an aspect, the manufacturing facility 202 can comprise a control device 214. The control device 214 can be configured to receive the additive information and user information from the food customization server 206 and/or user device 204. The control device 214 can be configured to control a plurality of manufacturing elements to produce a custom food product, such as a bean-shaped object with additives. For example, the control device 214 can communicate with the plurality of manufacturing elements via wireless or wired communication link 216, such as a bus, network link, and/or the like. The control device 214 can manage the plurality of manufacturing elements to provide for specific additives to be mixed with coffee beans (e.g. or other food) according to specific concentrations and other properties specified by the user (e.g. or based on default programmed values).

The plurality of manufacturing elements can comprise a grinder 218, a mixer 220, a shaping device 222, a sealer 224, a polisher 226, a packager 228, and/or the like. The grinder 218 can be configured for grinding a plurality of coffee beans into coffee grounds as described herein. The mixer 220 can be configured to mix an additive into the coffee grounds as described herein. The shaping device 222 can be configured to form the mixture into a plurality of bean-shaped objects as described herein. The sealer 224 can be configured to cover the plurality of bean-shaped objects with a sealing agent as described herein. The polisher 226 can be configured to polish the plurality of bean-shaped objects covered in the sealing agent.

The packager 228 can be configured to package the polished plurality of bean-shaped objects. For example, the packager 228 can package the plurality of bean-shaped objects (e.g., after sealing and polishing if performed) as a custom food product for the user as described herein. For example, the custom food product can be shipped to the user, to a retail location, and/or the like.

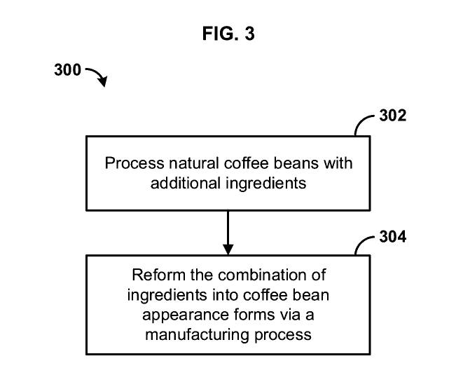

FIG. 3 is a flowchart illustrating an example process 300 for creating simulated coffee beans. At step 302, natural coffee beans can be processed with additional ingredients. For example, the additional ingredients may be vitamins, supplements, natural ingredients, medications, wellness ingredients, preservatives or any safely consumed additive consumable ingredient such as caffeine, or any combination thereof.

At step 304, the combination of ingredients can be reformed into coffee bean appearance forms via a manufacturing process. In an aspect, the simulated coffee may be colored to the desired pigment by the use of natural or artificial colors. In an aspect, the mixture of simulated coffee ingredients are pressed into forms of coffee beans using at least one of a mold, form, scoring element and shaping devices. The manufactured simulated bean can optionally be coated with a finishing agent, such as but not limited to coffee oil, wax or the like (e.g. to further maintain the structural integrity of the simulated beans). The formed simulated beans are optionally finished with a buffing process to replicate at least one of the same sheen, gloss or shine of a natural coffee bean in roasted or otherwise consumable form.

In an aspect, the finished product may be packaged in identical packaging as that containing coffee beans for sale, such as long sealable bags, sealed plastic pouches, tins, jars, cans, in loose form, and/or the like. The finished product may be pre-ground and sold in ground form in long sealable bags, single serving brewing containers or cartridges, sealed plastic packages, tins, jars, cans, in loose form and, and/or the like. The finished product can be consumed in a manner similar to regular coffee. For example, the simulated coffee beans may be ground in standard coffee grinders. The ground simulated coffee may be brewed in standard coffee brewing devices.

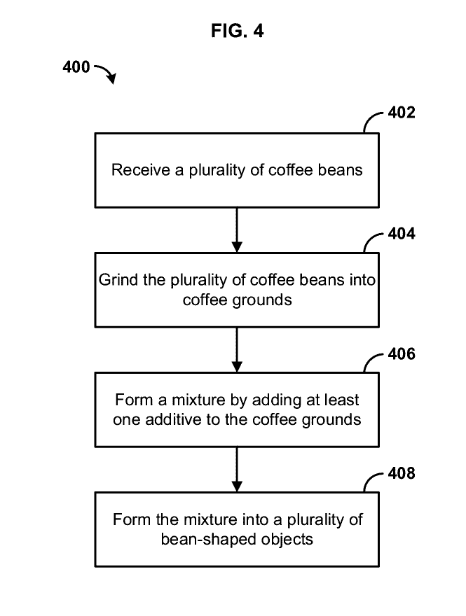

FIG. 4 is a flowchart illustrating an example method 400 for modifying a coffee bean. At step 402, a plurality of coffee beans can be received. The plurality of coffee beans can comprise a single variety or multiple varieties of coffee beans. The plurality of coffee beans can be received, for example, at a food processing facility and/or at a specific device (e.g., grinder) within a processing facility.

At step 404, the plurality of coffee beans can be ground into coffee grounds. For example, a grinder configured for grinding food, such as beans, coffee beans, and/or the like can be used. The coffee grounds can be ground to a specified level (e.g., particle size), such as any level on a scale from extremely coarsely ground to extremely finely ground (e.g., powdery).

At step 406, a mixture can be formed by adding at least one additive to the coffee grounds. For example, the additive can comprise a liquid, such as water, oil, and/or the like. The additive can comprise a binding agent configured to bind the coffee grounds together and/or bind the coffee grounds to other additives. The additive can comprise vitamins, supplements, natural ingredients, medications, wellness ingredients, preservatives or any safely consumed additive consumable ingredient such as caffeine, or any combination thereof. The additive can comprise flavorings, such as sugar, smoke, cinnamon, nutmeg, bitters, a combination thereof, and/or any other flavor. The additive can comprise can comprise wellness elements, such as caffeine, Echinacea, vitamins, ginkgo biloba, kava, CBD, a combination thereof, and/or the like. The additive can comprise medications, such as blood pressure medication, diabetes medication, heart medication, sexual dysfunction medication, birth control medications, vitamins, and/or the like. The additive can comprise natural or artificial colorings to yield a desired color. The additive can comprise natural or artificial colorings to yield a desired color. The supplemental ingredients can comprise Tetrahydrocannabinol (THC), Cannabidiol (CBD), cannabinol (CBN), combinations thereof, and the like. In a further aspect, the additive can comprise an extract from duboisia hopwoodii.

At step 408, the mixture can be formed into a plurality of bean-shaped objects. Forming the mixture into a plurality of bean-shaped objects can comprise freeze drying the mixture, injecting the mixture into a molding (e.g., bean-shaped molding), pressing the mixture into a molding (e.g., bean-shaped molding), and/or the like.

The method 400 can comprise covering the plurality of bean-shaped objects with a sealing agent. An example sealing agent can comprise wax, oil, a sugar based coating, and/or the like. As another example, the plurality of bean-shaped objects can be covered with a sealing agent by searing (e.g., or apply another heating and/or cooling process) to an exterior surface of the plurality bean-shaped objects.

The method 400 can comprise polishing the covered plurality of bean-shaped objects. For example, the plurality of bean-shaped objects can be provided to a buffer. The buffer can comprise a tube rotating with a glossing element, a tumbler buffer, and/or and the like. The buffer can be configured to run at different intensities, such as a gentle, normal, high, and/or the like. In some scenarios, the buffer (e.g., tumbler) can comprise (e.g., or be outfitted with) softened interior walls. The interior walls can be narrowed to limit the ‘fall’ or force exerted upon the plurality of bean-shaped objects, to maintain the integrity of the bean-shaped objects. In an aspect, the buffer can be configured to replicate a specified sheen, gloss, shine, and/or the like. For example, to replicate a sheen, gloss, and/or shine similar to a natural coffee bean in roasted or otherwise consumable form.

The method 400 can comprise packaging the plurality of polished bean-shaped objects. For example, the plurality of polished bean-shaped objects can be sealed within a package, such as a box, bag, pouch, and/or the like. The package can be a retail package for sale in a retail outlet, a customized package for a consumer, and/or the like. For example, the package can be addressed to and mailed to the user, the retail store, and/or the like. The package can resemble a typical retail coffee package.

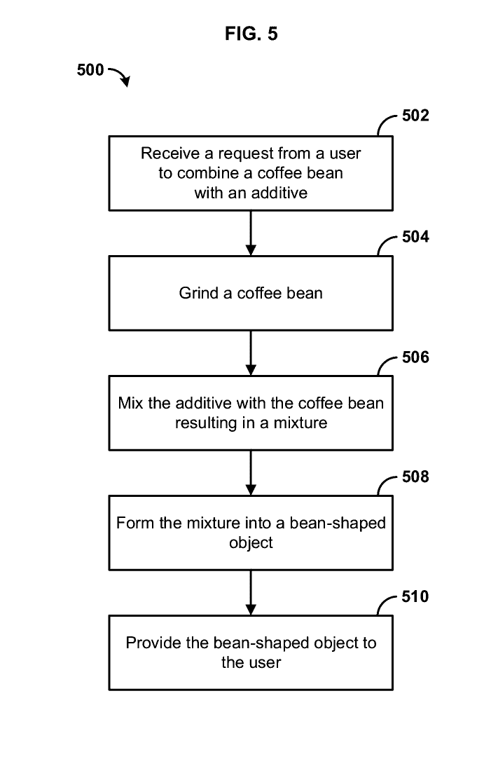

FIG. 5 is a flowchart illustrating an example method 500 for modifying a coffee bean. At step 502, a request to combine a coffee bean with an additive can be received from a user. For example, the additive can comprise a liquid, such as water, oil, and/or the like. The additive can comprise a binding agent configured to bind the coffee grounds together and/or bind the coffee grounds to other additives. The additive can comprise vitamins, supplements, natural ingredients, medications, wellness ingredients, preservatives or any safely consumed additive consumable ingredient such as caffeine, or any combination thereof. The additive can comprise flavorings, such as sugar, smoke, cinnamon, nutmeg, bitters, a combination thereof, and/or any other flavor. The additive can comprise can comprise wellness elements, such as caffeine, Echinacea, vitamins, ginkgo biloba, kava, CBD, a combination thereof, and/or the like. The additive can comprise medications, such as blood pressure medication, diabetes medication, heart medication, sexual dysfunction medication, birth control medications, vitamins, and/or the like. The additive can comprise natural or artificial colorings to yield a desired color. The additive can comprise Tetrahydrocannabinol (THC), Cannabidiol (CBD), cannabinol (CBN), combinations thereof, and the like. In a further aspect, the additive can comprise an extract from duboisia hopwoodii.

At step 504, a coffee bean can be ground. For example, a grinder configured for grinding food, such as beans, coffee beans, and/or the like can be used. The coffee can be ground to a specified level (e.g., particle size), such as any level on a scale from extremely coarsely ground to extremely finely ground (e.g. powdery).

At step 506, the additive can be mixed with the ground coffee bean resulting in a mixture. For example, a mixer can stir, shake, tumble, and/or otherwise mix the additive into the ground coffee bean. The additive can be mixed in specified proportion. Additive concentration can be received from the user. A computing device can control the mixing of the additive into the ground coffee beans to achieve the additive concentration.

As an illustration, the additive can be a medication prescribed to the user. Prescription information for the user can be received from the user, a pharmacy, a medical practice, and/or the like. The computing device can control the mixing of the additive into the ground coffee beans. For example, the additive can be mixed such that a certain portion (e.g., amount sufficient to brew a cup of coffee) of the mixture can provide a prescribed amount and/or concentration of the medication.

At step 508, the mixture can be formed into a pellet. For example, the pellet can comprise a pill, ball, bean-shaped object, and/or the like. Forming the mixture into a pellet can comprise freeze drying the mixture, injecting the mixture into a molding (e.g., bean-shaped molding), pressing the mixture into a molding (e.g., bean-shaped molding), and/or the like.

The method 500 can comprise covering the pellet with a sealing agent. An example sealing agent can comprise wax, oil, a sugar based coating, and/or the like. As another example, pellet can be covered with a sealing agent by searing (e.g., or apply another heating and/or cooling process) to an exterior surface of the plurality bean-shaped objects.

The method 500 can comprise polishing the covered pellet. For example, the pellet can be provided to a buffer. The buffer can comprise a tube rotating with a glossing element, a tumbler buffer, and/or and the like. The buffer can be configured to run at different intensities, such as a gentle, normal, high, and/or the like. In some scenarios, the buffer (e.g., tumbler) can comprise (e.g., or be outfitted with) softened interior walls. The interior walls can be narrowed to limit the ‘fall’ or force exerted upon the plurality of bean-shaped objects, to maintain the integrity of the bean-shaped objects. In an aspect, the buffer can be configured to replicate a specified sheen, gloss, shine, and/or the like. For example, to replicate a sheen, gloss, and/or shine similar to a natural coffee bean in roasted or otherwise consumable form.

At step 510, the pellet can be provided to the user to the user. For example, the pellet sealed within a package, such as a box, bag, pouch, and/or the like. The package can be addressed to and mailed to the user. The pellet can be provided to the user to fulfill the request.

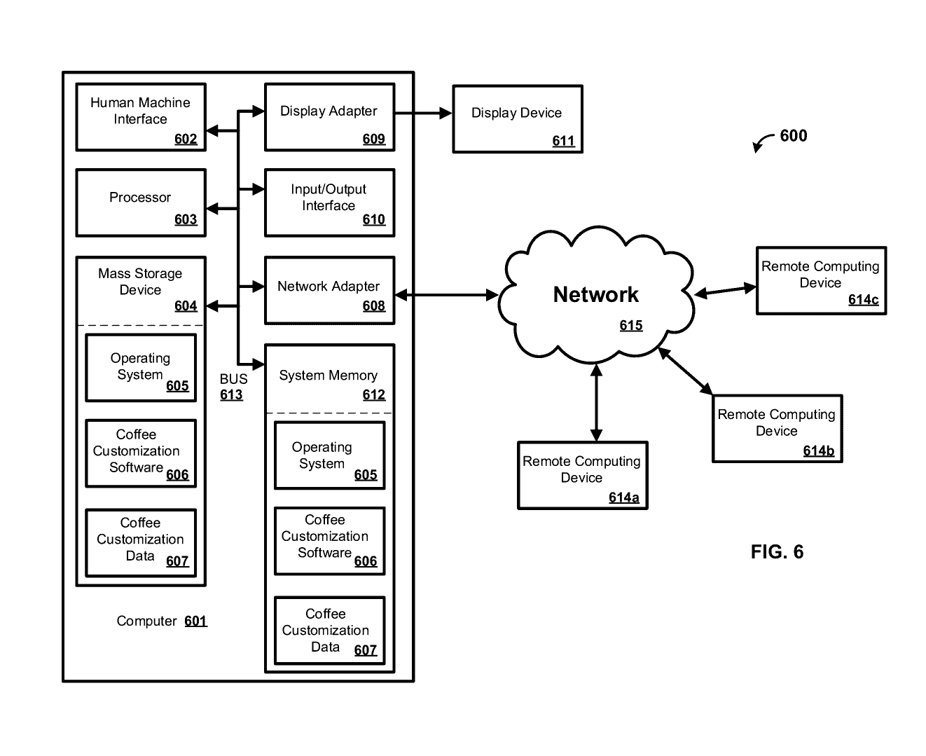

In an exemplary aspect, the methods and systems can be implemented on a computer 601 as illustrated in FIG. 6 and described below. By way of example, the control device 214, the food customization server 206, and the user device 204 can be computers as illustrated in FIG. 6. Similarly, the methods and systems disclosed can utilize one or more computers to perform one or more functions in one or more locations. FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 603, a system memory 612, and a system bus 613 that couples various system components including the one or more processors 603 to the system memory 612. The system can utilize parallel computing.

The system bus 613 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the one or more processors 603, a mass storage device 604, an operating system 605, coffee customization software 606, coffee customization data 607, a network adapter 608, the system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as the coffee customization data 607 and/or program modules such as the operating system 605 and the coffee customization software 606 that are immediately accessible to and/or are presently operated on by the one or more processors 603.

In another aspect, the computer 601 can also comprise other removable/non-removable, volatile/non-volatile computer storage media. By way of example, FIG. 6 illustrates the mass storage device 604 which can provide non-volatile storage of computer code, computer readable instructions, data structures, program modules, and other data for the computer 601. For example and not meant to be limiting, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, the operating system 605 and the coffee customization software 606. Each of the operating system 605 and the coffee customization software 606 (or some combination thereof) can comprise elements of the programming and the coffee customization software 606. The coffee customization data 607 can also be stored on the mass storage device 604. The coffee customization data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 603 via the human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, the display device 611 can also be connected to the system bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), or a projector. In addition to the display device 611, other output peripheral devices can comprise components such as speakers (not shown) and a printer (not shown) which can be connected to the computer 601 via the Input/Output Interface 610. Any step and/or result of the methods can be output in any form to an output device. Such output can be any form of visual representation, including, but not limited to, textual, graphical, animation, audio, tactile, and the like. The display device 611 and computer 601 can be part of one device, or separate devices.

The computer 601 can operate in a networked environment using logical connections to one or more remote computing devices 614a,b,c. By way of example, a remote computing device can be a personal computer, portable computer, smartphone, a server, a router, a network computer, a peer device or other common network node, and so on. Logical connections between the computer 601 and a remote computing device 614a,b,c can be made via a network 615, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 601, and are executed by the one or more processors 603 of the computer. An implementation of the coffee customization software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM. ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for forming a coffee product comprising:
receiving a plurality of coffee beans;
grinding the plurality of coffee beans into coffee grounds;
forming a mixture by adding at least one additive to the coffee grounds; and
forming the mixture into a plurality of bean-shaped objects.

2. The method of claim 1, further comprising covering the plurality of bean-shaped objects with a sealing agent.

3. The method of claim 2, further comprising polishing the covered plurality of bean-shaped objects.

4. The method of claim 1, further comprising packaging the plurality of polished bean-shaped objects.

5. The method of claim 1, wherein the additive comprises vitamins, supplements, natural ingredients, medications, wellness ingredients, preservatives or any safely consumed additive consumable ingredient such as caffeine, or any combination thereof.

6. The method of claim 1, wherein forming the mixture into a plurality of bean-shaped objects comprises freeze drying the mixture.

7. The method of claim 1, wherein forming the mixture into a plurality of bean-shaped objects comprises pressing the mixture into a bean-shaped molding.

8. A method comprising:
receiving a request from a user to combine a coffee bean with an additive;
grinding a coffee bean;
mixing the additive with the ground coffee bean resulting in a mixture;
forming the mixture into a pellet; and
providing the pellet to the user.

9. The method of claim 8, further comprising covering the pellet with a sealing agent.

10. The method of claim 9, further comprising polishing the pellet.

11. The method of claim 8, further comprising packaging the pellet.

12. The method of claim 8, wherein the additive comprises vitamins, supplements, natural ingredients, medications, wellness ingredients, preservatives or any safely consumed additive consumable ingredient such as caffeine, or any combination thereof.

13. The method of claim 8, wherein forming the mixture into a plurality of bean-shaped objects comprises freeze drying the mixture.

14. The method of claim 1, wherein forming the mixture into the pellet comprises pressing the mixture into a bean-shaped molding.

15. A system comprising:
a grinder configured grinder a plurality of coffee beans into coffee grounds;
a mixer configured to mix an additive into the coffee grounds;
a forming device configured to form the mixture into a plurality of bean-shaped objects;
a sealer configured to cover the plurality of bean-shaped objects with a sealing agent;
a polisher configured to polish the plurality of bean-shaped objects covered in the sealing agent;
a packager configured to package the polished plurality of bean-shaped object; and
a computing device configured to control the grinder, the mixer, the forming device, the sealer, the polisher, the packager, or a combination thereof.

16. The system of claim 15, wherein the forming device is configured for starch casting.

17. The system of claim 15, further comprising a cooler, configured for cooling the plurality of bean-shaped objects prior to being coated with the sealing agent.

18. The system of claim 17, wherein the cooler is configured for freeze drying.

19. The system of claim 15, wherein the additive comprises vitamins, supplements, natural ingredients, medications, wellness ingredients, preservatives or any safely consumed additive consumable ingredient such as caffeine, or any combination thereof.

20. The system of claim 15, wherein the sealing agent comprises one or more of natural oil or wax.
